(19) United States
(12) Patent Application Publication
(10) Pub. No.: US 2012/0325114 A1
(43) Pub. Date: Dec. 27, 2012

(54) METHOD OF MANUFACTURING COLD ASPHALT, AND PRODUCT-BY-PROCESS FOR SAME

(75) Inventor: John T. ACKERMAN, Lynnwood, WA (US)

(73) Assignee: YK Holdings LLC, Everett, WA (US)

(21) Appl. No.: 13/605,039

(22) Filed: Sep. 6, 2012

Related U.S. Application Data
(62) Division of application No. 12/495,567, filed on Jun. 30, 2009.
(60) Provisional application No. 61/133,778, filed on Jul. 2, 2008.

(51) Int. Cl. C08L 95/00

(52) U.S. Cl. 106/273.1

(57) ABSTRACT

A heatless method of manufacturing cold asphalt, such as for road repair and construction, that may be easily produced at or near a job site. The method includes the introduction of RAP (recycled asphalt and a small amount of new asphalt), additive oil, and optional sand lime (limestone powder) into mixing apparatus. The mixing apparatus includes one hopper for RAP, a live feed for additive oil, and optional live feed for lime, conveyors, and a controller that is programmed to determine the correct proportion of RAP, oil, and optional lime The invention also includes a product-by-process in which cold asphalt mix is produced. The end product is essentially non-toxic with little to no VOCs and HAPs, has long shelf-life, and is produced, stored, used, and compacted at ambient temperature.

### RELATED APPLICATION

The present application is a divisional application of Ser. No. 12/495,567, filed on Jun. 30, 2009, and entitled “Apparatus For Producing Cold Asphalt, Method of Manufacturing Cold Asphalt, and Product-By-Process for Same,” which claims priority to U.S. Provisional Patent Application Ser. No. 61/133,778, filed on Jul. 2, 2008, and entitled “Apparatus For Producing Cold Asphalt, Method of Manufacturing Cold Asphalt, and Product-By-Process for Same.”

### TECHNICAL FIELD

The present invention relates generally to a method that can more cost effectively and locally produce cold asphalt at ambient temperature used for filling potholes and road repair and construction made from recycled asphalt with or without the addition of virgin asphalt.

### BACKGROUND OF THE INVENTION

Cold asphalt is used to repair roads, and particularly, cracks and potholes without the expense of hot asphalt repairs. Most cold asphalt is produced by blending asphalt aggregate and a “cut back,” such as kerosene, diesel, jet fuel, or other light distillates, which will evaporate in use.

A particular type of cold asphalt process is described in U.S. Patents to Kitagawa and all assigned to Hikarigiken Co., Ltd. of Kyoto, Japan. These patents are U.S. Pat. No. 6,117,227 issued Sep. 12, 2000 and entitled “Asphalt Paving Mix Formed of Recycled Asphalt Concrete and New Asphalt for Paving at Ambient Temperatures and a Process for Making the Same”; U.S. Pat. No. 6,214,103 issued Apr. 10, 2001 and entitled “Asphalt Paving Mix for Paving at Ambient Temperatures and a Process for Making the Same”; and U.S. Pat. No. 6,139,612 (Kitagawa and Yokokawa) issued on Oct. 31, 2000 and entitled “Asphalt Paving Mix Formed of Recycled Asphalt Concrete for Paving at Ambient Temperatures and a Process for Making the Same” (collectively the “Kitagawa patents”). These patents disclose an asphalt mix and a process that combines crushed recycled asphalt at ambient temperature with an additive oil in which the resulting mixture has aggregate grains that have softened and swelled with the additive oil to amalgamate when the aggregate grains are compacted at ambient temperature. Further improvements included combining mostly recycled asphalt with new asphalt and a granular material, e.g., sand, along with the additive oil, and, later the addition of lime The resulting asphalt concrete mix achieves sufficient immediate strength after compacting at ambient temperature. Because the asphalt mix does not congeal easily, or contain solvents for curing, it is particularly suited for long-term storage.

One of the benefits of using cold asphalt over hot asphalt is that hot asphalt typically hardens in approximately two hours. Thus, it is critical to a job's success to carefully coordinate the timing of the job relative to receiving the supply of hot asphalt. Other major benefits of cold asphalt made using the Kitagawa patented mixture and process over other cold asphalt products are: 1) that it uses a significant amount of recycled asphalt pavement (e.g., up to 98%); 2) it is produced at ambient temperature; and 3) the additive oil used has a low vapor pressure and toxicity. Unlike traditional cold asphalt, the additive oil in the Kitagawa patents contain no kerosene, diesel fuel, naphtha, jet fuel, or other similar materials all of which emit high amounts of VOCs (volatile organic compounds) or HAPs (hazardous air pollutants) during the production, application, and curing process. Because there is little to no toxicity and smell, special handling/special handling equipment is unnecessary. Bags of the mix and bulk forms of the mix can be stored for long periods of time. Also, the mix is applied at ambient temperatures for road repairs, thus avoiding the potential burns among workers who are applying hot asphalt. And workers also avoid the risk of exposing them to amounts of volatile organic compounds (VOCs, HAPs) found in typical cold asphalt.

Commercial success of the Kitagawa patented cold asphalt mix has been strong. Fifty pound bags of the mixture are found on shelves under the U.S. COLD PATCH trademark at home improvement stores and primarily used by the homeowner or small contractor. Large scale road repair and general construction requires significant supplies that shelf-store bag supplies cannot adequately match.

At present, most cold asphalt is manufactured at large hot asphalt manufacturing plants by modifying existing production runs to meet the chemical composition of the desired cold asphalt mix. Known prior art methods require application of heat. While limited productions can be made for bagging and distribution and sale, larger construction projects have proven to be less optimal as the construction project needs to be located relatively close to the asphalt plant to make the transportation cost of the cold asphalt economically viable. Further, existing batches run at modified hot asphalt plants are expensive and inefficient.

### SUMMARY OF THE INVENTION

The present invention is directed to machinery that produces cold asphalt more efficiently, cost-effectively, and takes up less space relative to existing modified hot asphalt producers. Further, the present invention allows the user/owner to produce cold asphalt for use in bags or bulk. This can be accomplished either the job location or at least in the city or municipality of the origin of the construction project, in order to make bulk product available for larger repairs and paving applications which are currently cost prohibitive.

The machinery of the present invention includes one or more hoppers in which screened recycled asphalt pavement (“RAP”) and optional granular material, such as sand, are loaded into respective hoppers and conveyed, such as through a screw drive or belt, to a mixer in desired amounts. According to one embodiment of the present invention, one hopper loads and conveys the RAP, and the optional sand is loaded and conveyed into a second hopper. Additive oil is introduced and sent to the mixer. Optional lime is added to the mix through controlled intervals. Once the mixture reaches the desired consistency, the mixture is conveyed to a bagging assembly or to be delivered in its bulk form to a particular application (e.g., a job site).

A controller controls the amount and speed of the overall RAP, optional sand with or without virgin asphalt, additive oil, and optional lime. According to one aspect of the invention, a desired composition is approximately 43-98% RAP, 0-45% sand, and the remainder in additive oil. According to one aspect of the invention, the desired composition includes 3-10% lime.

According to another aspect of the invention, a desired composition is approximately 43-60% RAP and 30-45% sand, 3-10% lime, and the reminder percentage is additive oil.

According to yet another aspect of the invention, another desired composition is comprised of up to 98% RAP and the remainder additive oil. In this version, only one hopper is required to be activated.

The hoppers, mixer, and feeders for oil and optional lime can be made into a relatively compact size that may be used on a trailer at a job site or as a piece of municipal equipment installed where other type industrial equipment is kept and that can also accommodate truck loads of dumped raw RAP and optional sand.

These and other advantages will become more apparent upon review of the Drawings, the Detailed Description of the Invention, and the Claims.

### BRIEF DESCRIPTION OF THE DRAWINGS

Like reference numerals are used to designate like parts throughout the several views of the drawings, wherein:

FIG. 1 is a schematic view of the apparatus of the present invention;

FIG. 2 is a schematic view of the apparatus of an alternate embodiment of the present invention;

FIG. 3 is front view of the embodiment of the apparatus of FIG. 2;

FIG. 4 is a top plan view of the embodiment of FIG. 2;

FIG. 5 is a right side view of the embodiment of FIG. 2;

FIG. 6 is a schematic view of the lime feeder, conveyor, feeder, and load cell related to the embodiment of FIG. 2;

FIG. 7 is an end view of a screw used to mix materials in the mixer;

FIG. 8 is a front view of the mixing screw of FIG. 7;

FIG. 9 is a front view of another embodiment of the apparatus and loaded onto a trailer for mobility;

FIG. 10 is a top view of the apparatus of the embodiment of FIG. 9;

FIG. 11 is a left end view of the apparatus of the embodiment of FIG. 9;

FIG. 12 is a right end view of the apparatus of the embodiment of FIG. 9;

FIG. 13 is a section view of one hopper taken substantially along lines 13-13 of FIG. 10;

FIG. 14 is a section view of one hopper taken substantially along lines 14-14 of FIG. 10;

FIG. 15 is an end view of a lime bag frame of the apparatus of the embodiment of FIG. 9;

FIG. 16 is the opposite end view from FIG. 15 of a lime bag frame of the apparatus of the embodiment of FIG. 9;

FIGS. 17-21 are detail views of hopper motion stops that may be used in the frame work of the machine of either embodiment; and

FIGS. 22-33 are control screen shots to control speed, volume of mixture to the mixer, and to obtain the desired mixture characteristics during the mixing phase.

### DETAILED DESCRIPTION OF THE INVENTION

RAP comes from recycled asphalt pavement that has been crushed and screened so that the aggregate particles are fairly small (such as can pass through a number ⅜-screen) and, may be mixed with up to typically 4-10% new asphalt as needed to boost the asphalt content of the finished product. RAP typically makes up to 43-98% of the overall cold asphalt mixture. Granular material, e.g., sand, broadly defined as silicates or RAP and/or aggregates that have run through a No. 4 sieve or a combination thereof, typically makes up to 0-45% of the overall cold asphalt mixture. Hydrocarbon oil having a low vapor pressure so as to be practically nonvolatile at ambient temperatures accounts for a relatively small percentage amount of the overall mixture, but allows for individual surfaces of aggregate grains to swell by absorbing the oil.

In cases where the asphalt pavement (RAP) does not contain sufficient residual asphalt, virgin asphalt would be blended with sand to form the granular material. This brings the resulting mixture to a desired level of asphalt.

Limestone powder (crushed calcium carbonate—CaCo3—or other synthetic form such as dolomite) and generally referred to herein as “lime” may be added in the approximately 3-10% range. The RAP percentage would thus be reduced accordingly. The lime is also used as a drying agent/preservative when the cold asphalt is bagged.

In use, the cold asphalt becomes very hard and durable when compacted, as opposed to evaporation or cooling that is required for hot or typical cold asphalt construction projects.

Currently, the cold asphalt of the above-referenced Kitagawa patents, which are hereby incorporated by reference, are manufactured in large hot asphalt plants that required modification to run a batch of cold asphalt. The present machinery will allow the cold asphalt mixture to be produced close to or at the construction site so that large scale repairs or paving applications may also be made at ambient temperature.

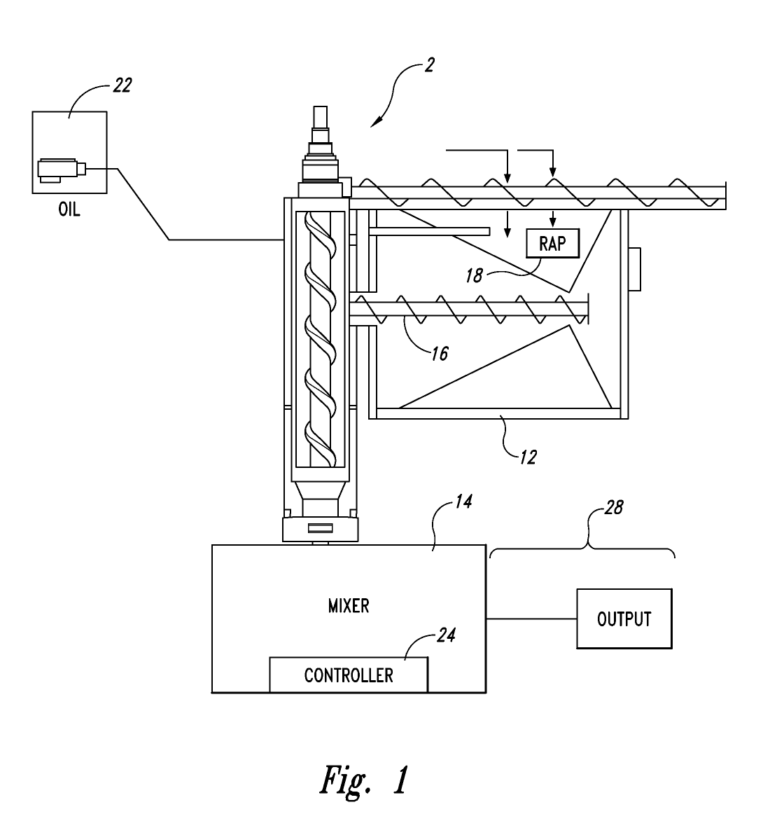

Referring to FIG. 1, a first embodiment of the present invention 2 is a machine to produce cold asphalt and a method and product-by-process for same. Machine 2 includes one hopper 12 of which its contents are fed into a mixer 14 via conveyors 16, such as 9 inch feed screws as illustrated. RAP 18 is comprised of up to 98% recycled asphalt, aggregate. RAP 18 is loaded into hopper 12.

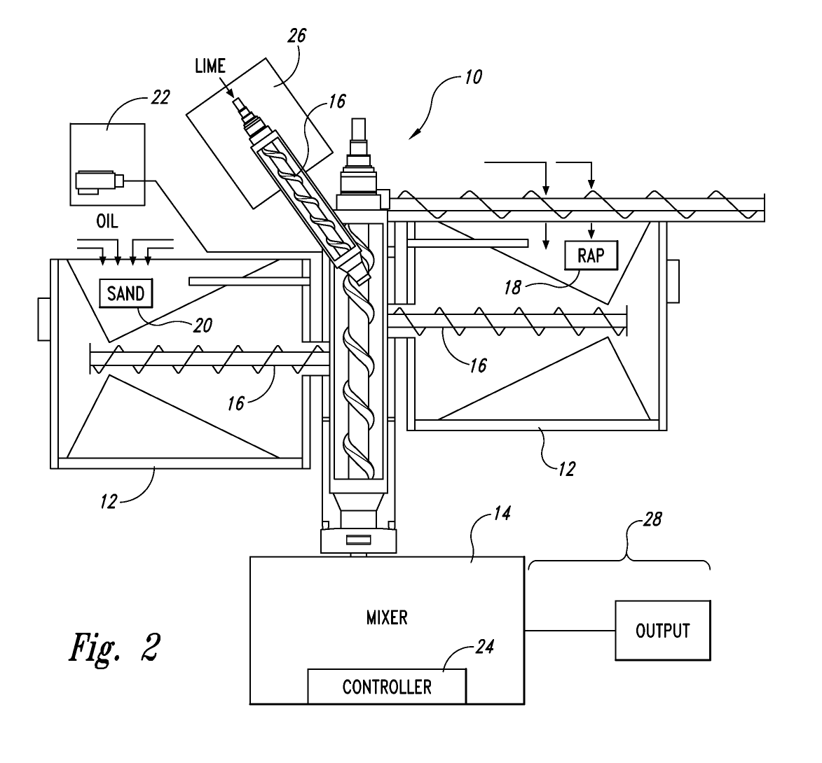

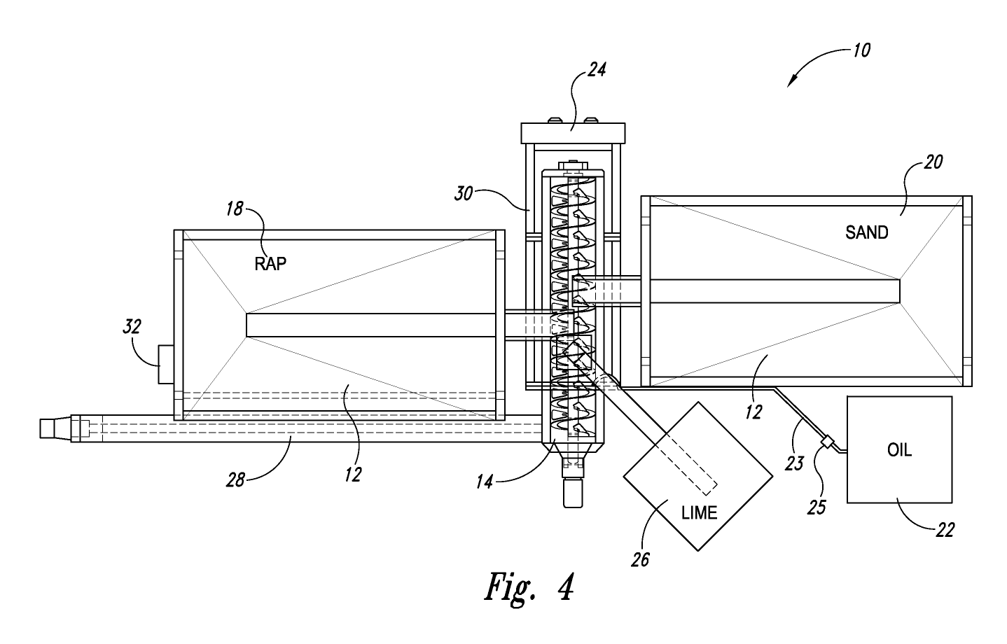

Referring now also to FIGS. 2-4, an optional second hopper 12 may be fed granular material, e.g., sand 20. Sand is defined broadly that can include fine RAP that has passed through a No. 4 sieve. The overall mixture can comprise in excess of 90% recycled asphalt.

In either embodiment, additive hydrocarbon oil 22 is pumped into the mixer 14. The mixer is controlled by controller 24, which will be discussed in further detail below.

The controller 24 is programmed to control the mix ratios, quantity, and time for mixing that can include the processes defined herein and in the Kitagawa patents. When the desired resulting mixture (cold asphalt) is then moved or conveyed through an outlet 28 of the mixer for immediate use, bagging for distribution and sale (such as in 50 lb bags that can be sold to the retail stores), or for bulk application, or for long term storage.

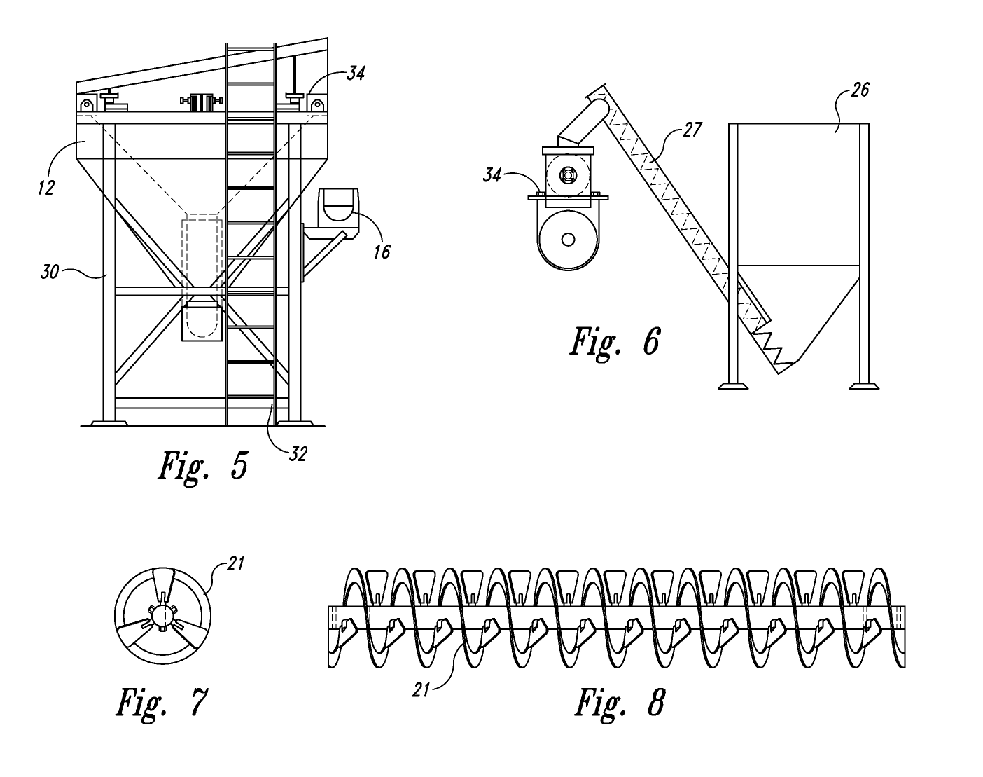

As briefly discussed above, a second embodiment of the present invention is disclosed in FIGS. 2-8 in which the machine 10 includes oppositely-situated hoppers 12 with feed screw conveyors conveying each hopper's respective load to the mixer 14 that is roughly centrally-positioned between the two hoppers. The mixer may include a screw mechanism 21 (such as a 20 inch large screw mechanism illustrated in FIGS. 6 and 7) for turning and mixing the received RAP and sand. The controller 24 controls the amount, speed, and time of the mixing before the mixture is conveyed through the outlet 28. Additive hydrocarbon oil 22 is pumped into the mixer via an oil feed line 23 and an oil pump 25 the rate of which is controlled by the controller. Lime (limestone powder) 26 may be fed into the mixer by its own conveyor 27 (for example, through a 5 inch feed screw as illustrated in FIG. 5 and again at a rate and amount controlled by the controller).

The machine of the either embodiment may be installed at a job site or inside a warehouse facility, such as one operated by a municipality. The overall frame 30 supports the hoppers, conveyors, controller, mixer, and may contain traditional safety and operational features, such as a ladder 32, as shown.

Load cells 34 detect the load deflection and send a signal to the controller 24 in which to measure overall weight of the load from the hoppers. The controller then uses the load cell signal to determine speed of the conveyed load (e.g., RAP, sand) to get the correct composition percentage into the mixer. Once the hoppers 12 are connected to the load cells 34 and support frame 30, hopper motion stops 36 may be added, as illustrated in FIGS. 17-21 to provide additional structural integrity when supporting heavy and fully loaded hoppers.

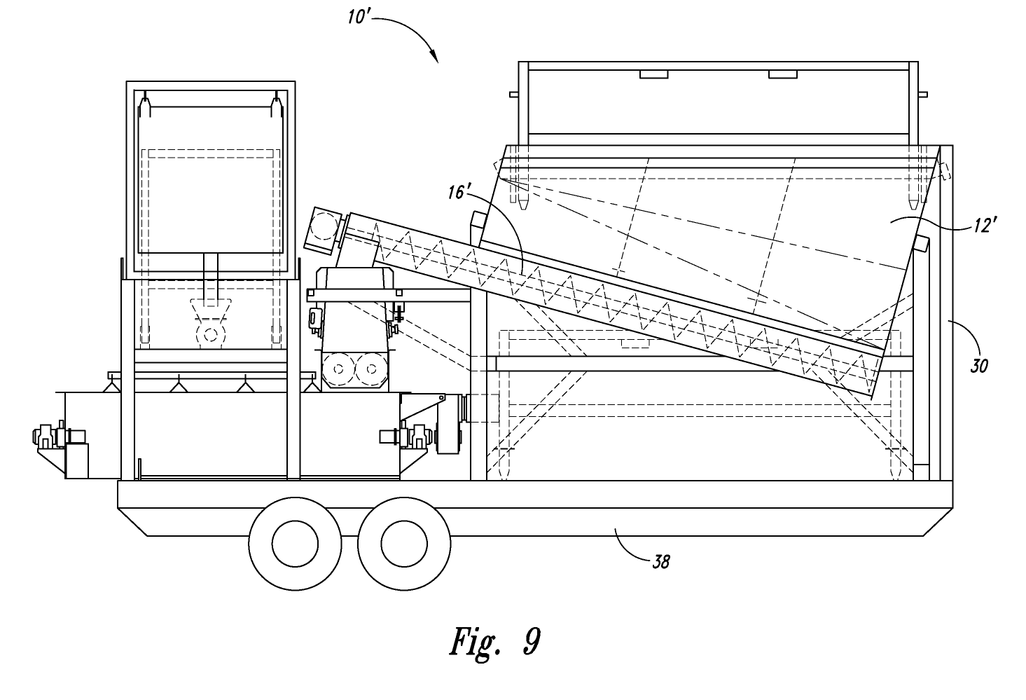

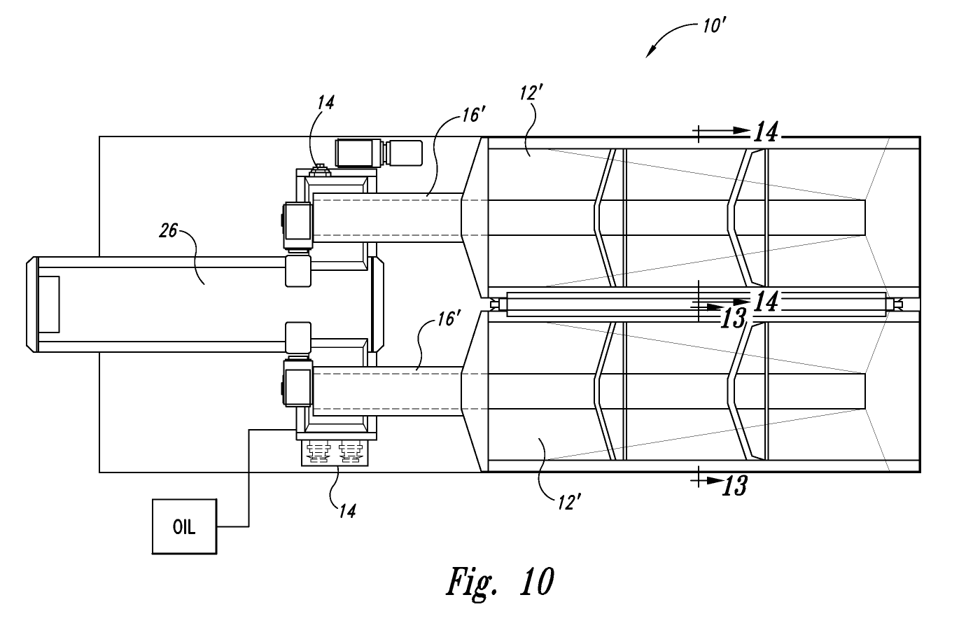

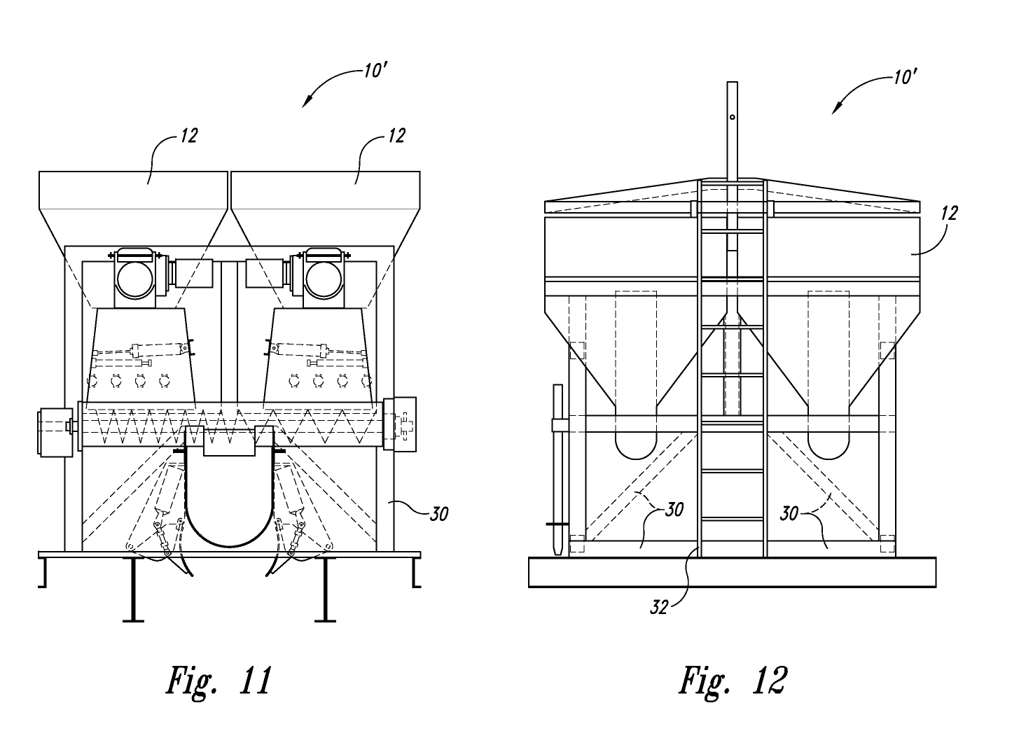

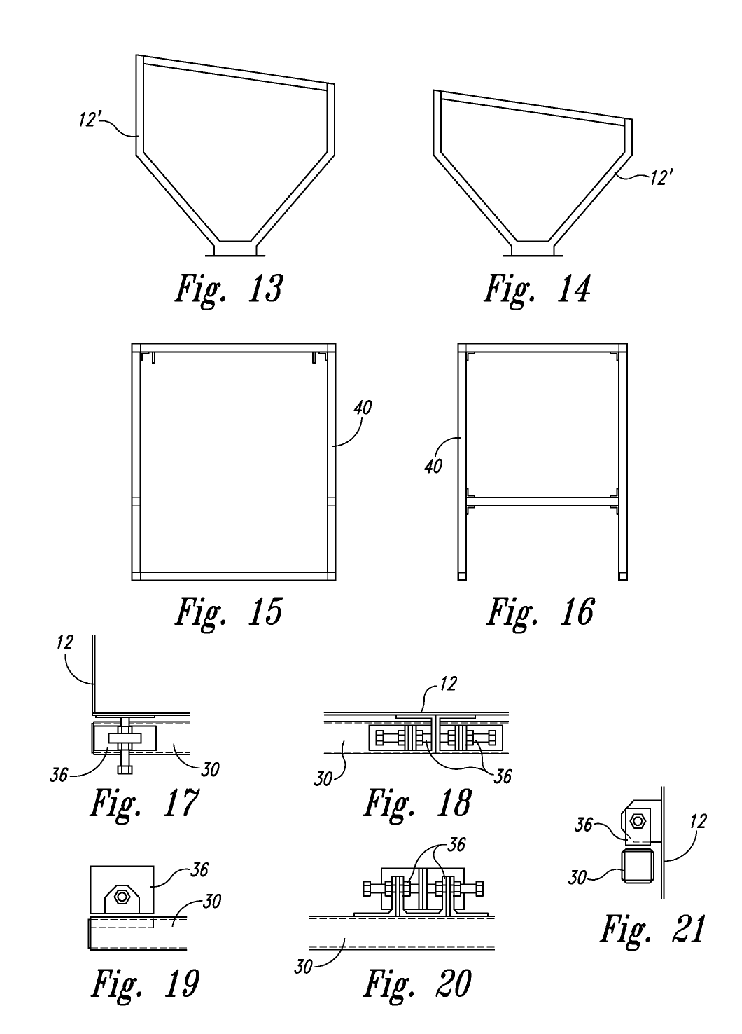

A third embodiment of the machine 10′ is illustrated in FIGS. 9-16 in which the hoppers 12′ are positioned adjacent each other to minimize the space footprint. Section views of the hopper ribs are illustrated in FIGS. 13 and 14 in which a slightly smaller shape and angled shape may be used. In this embodiment, the machine is sufficiently compact that it can be placed on a trailer 38 for mobility. The conveyors 16′ may still be 9 inch feed screws, such as illustrated. The first embodiment, discussed above and schematically illustrated in FIG. 1, may also be adapted for a trailer application.

The additive hydrocarbon oil may be in a separate container on the ground beside the machine 10′ sitting on the trailer. The optional lime 26 is illustrated with its own support structure 40 for the lime bag and may be physically located at the front of the trailer near the output.

The same hopper motion stops described in the first embodiment and illustrated in detail in FIGS. 17-21 may be utilized in the second embodiment, as well.

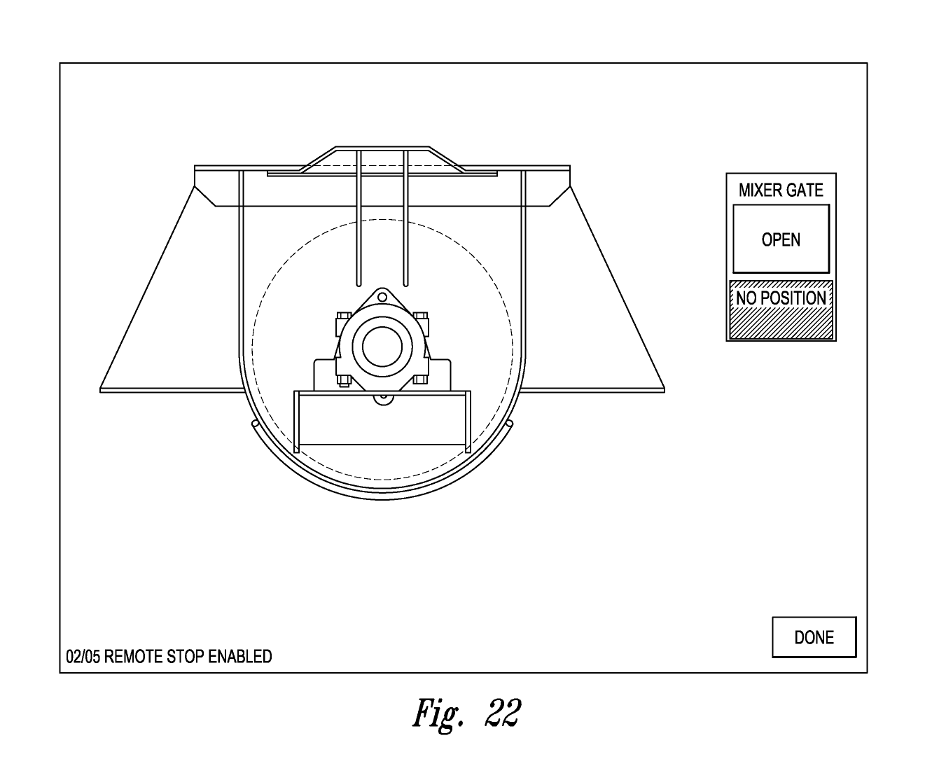

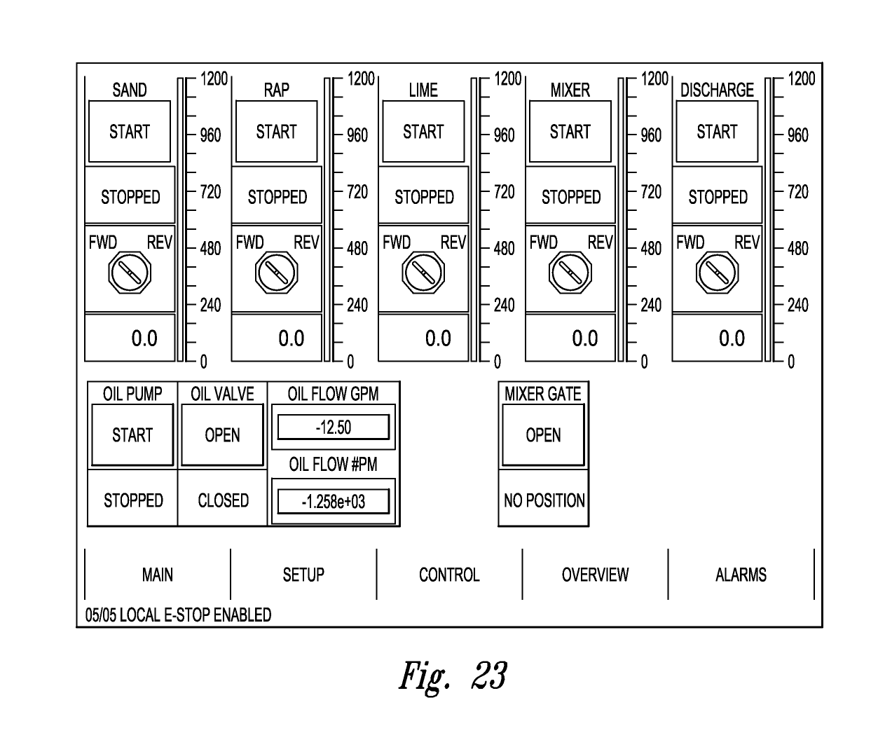

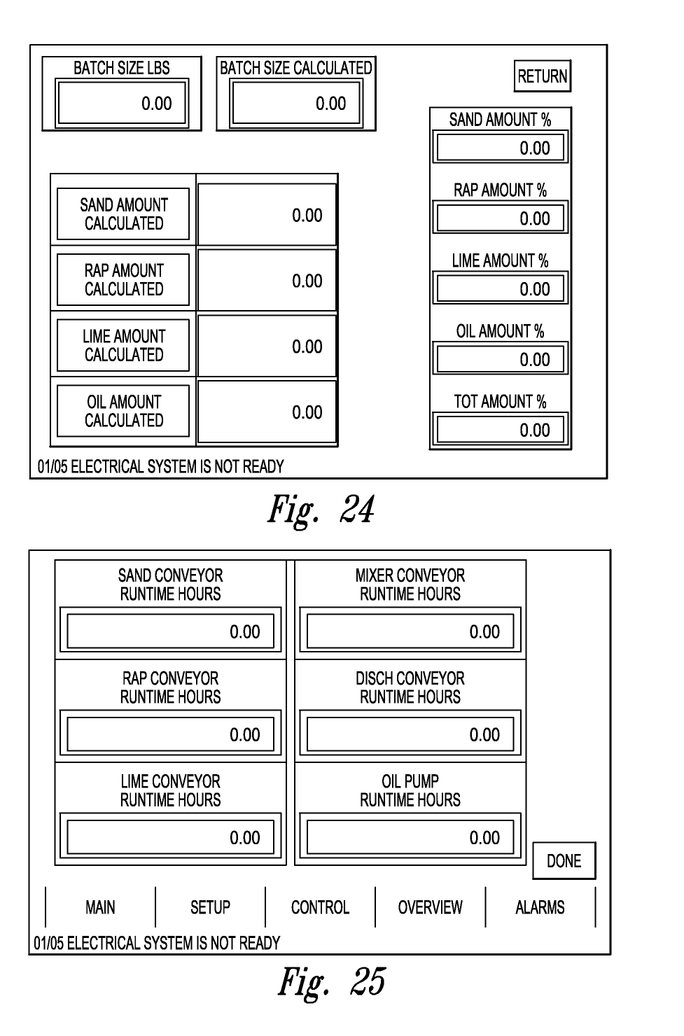

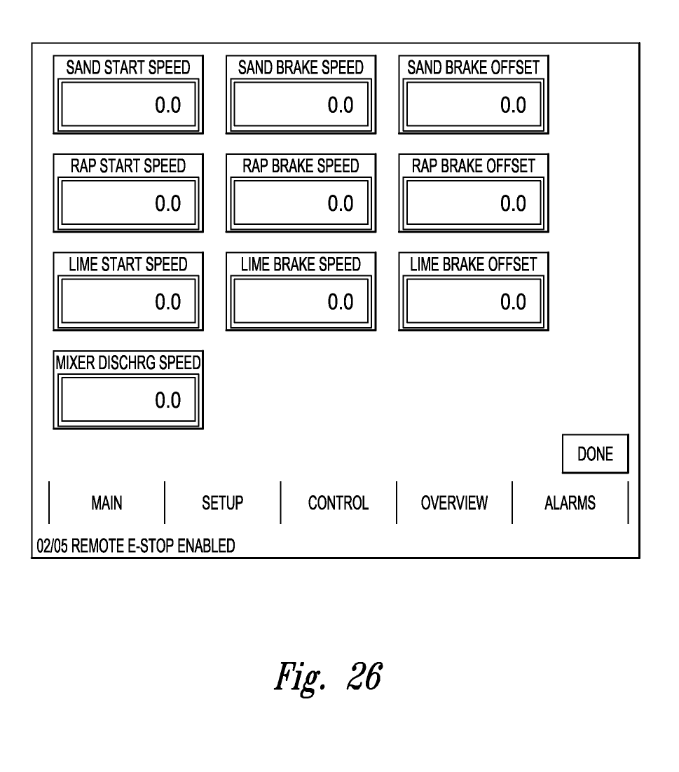

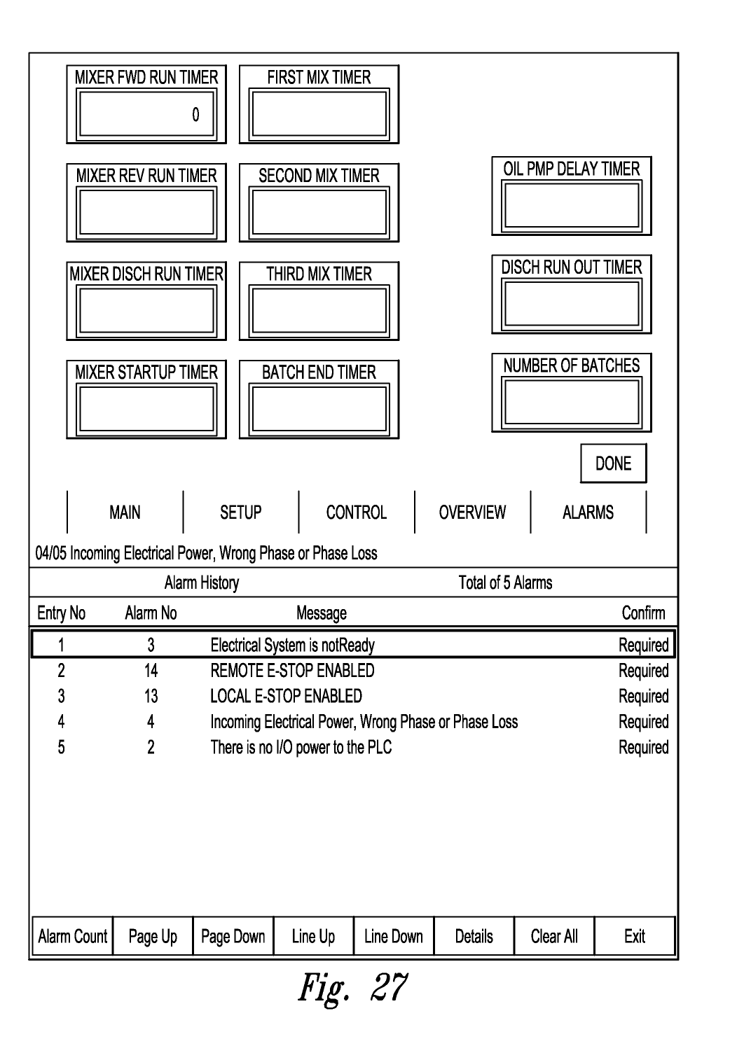

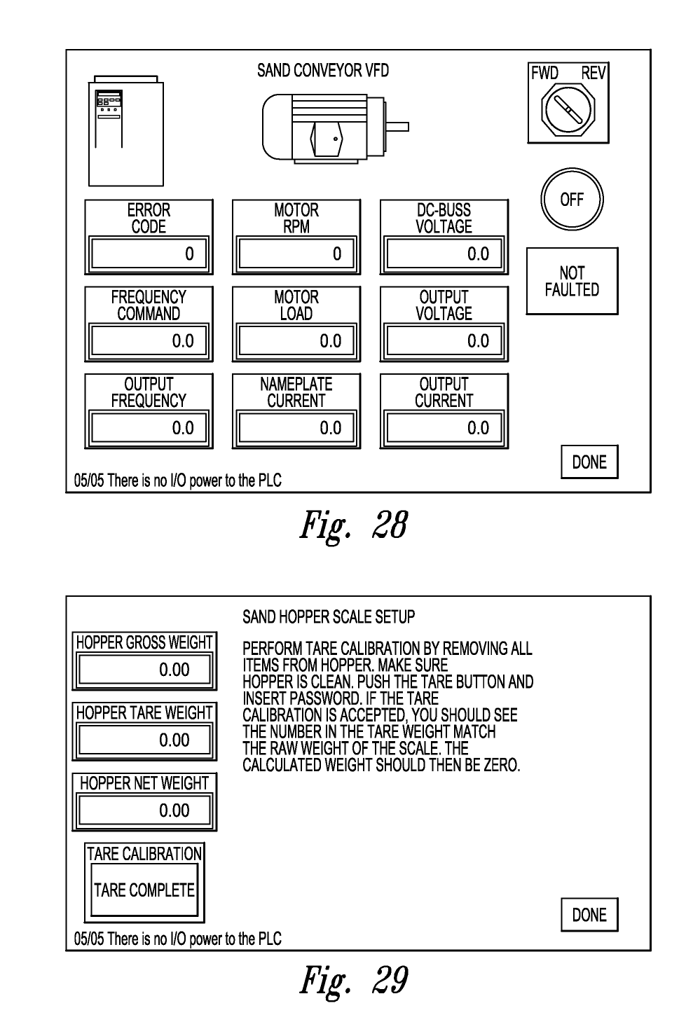

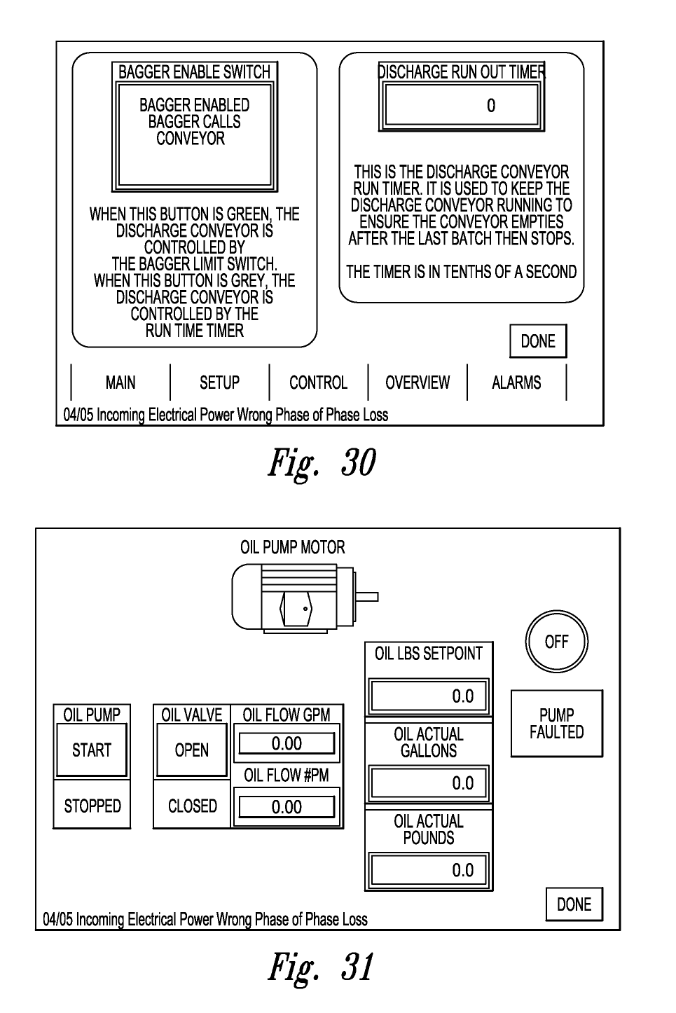

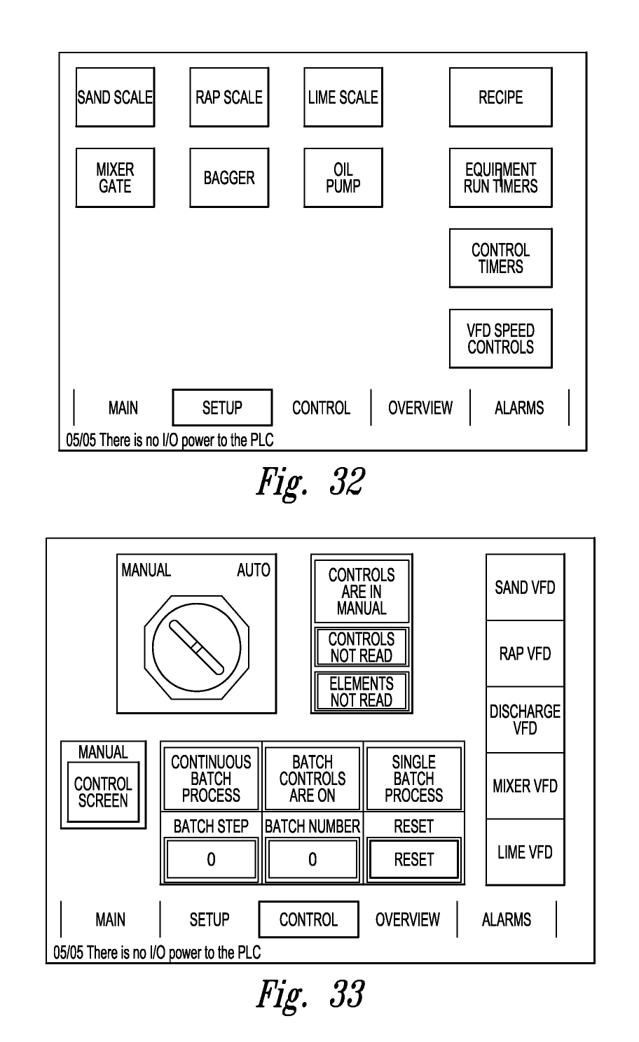

Referring now to the controller 24 and to FIGS. 22-33, the controller feeds from the RAP hopper, sand hopper, the additive oil, and lime to create the desired cold asphalt mixture per batch run. As discussed above, the desired cold asphalt mixture is made up of approximately 43-98% RAP (stone aggregate, recycled asphalt, new asphalt), 0-45% sand (which itself may be a form of fine RAP), and the rest additive hydrocarbon oil. In this manner, the overall mixture may contain over 98% recycled asphalt, which has great environmental benefits. According to another aspect, limestone powder (lime) is introduced to the mixture at a content percentage of approximately 3-10. The controller determines the speed (timing) of each conveyor to the mixer, which essentially controls the percentage content as the various composition matters have significantly different weights. The controller also determines the run and discharge of the mixer per batch and sends out the appropriate instructions to the conveyors and gates at the output.

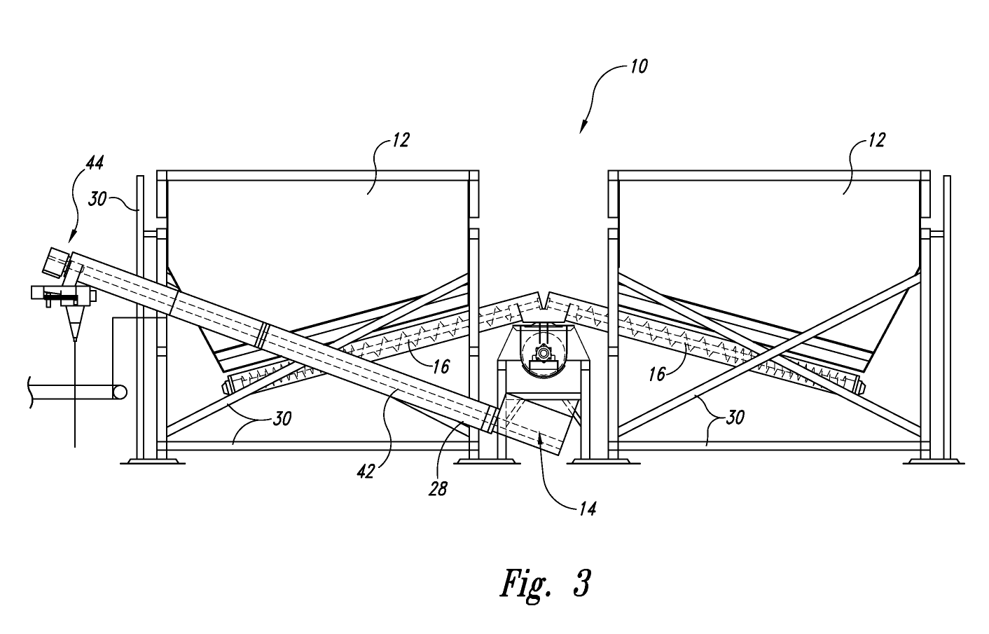

Once the desired mixture is attained, the controller signals to the mixer to send the mixture to the outlet (generally denoted as “28”) in which the mixture is carried by a conveyor 42 out of the mixer through a gate or portal and to a desired location, such as into a bagging apparatus illustrated at 44 in FIG. 3.

One of ordinary skill in the art would know how to add the appropriate motors, sensors, and switches, check valves, etc. to effectuate the general electrical and mechanical functions and are, therefore, not further discussed.

In any embodiment, the production of cold asphalt can be greatly increased. For example, with large hoppers, motors, and mixers, the output of cold asphalt can be over 500 tons produced a day. At this rate, cold asphalt can be sufficiently produced for large road repairs and paving applications, as opposed to mere pothole filling via 50 lb bags.

Further, the use of Kitagawa patented cold asphalt mixture with its hydrocarbon oil has little to no VOCs and HAPs that are indigenous in other typical cold asphalt products. The stored product has low toxicity and poses little health hazard to employees and workers.

Benefits of the present invention include the production of an environmentally-friendly cold asphalt at or near the construction or repair site. Large hot asphalt plants no longer need to be modified for cold asphalt batch runs. No heat is required. Cold asphalt made using the process described in the Kitagawa patents does not harden by cooling temperatures but does under compaction. It can be stored longer and used year long as opposed to putting all road projects on hold except for the summer The present invention allows users to manufacture the cold asphalt at the job site, particularly in the mobile version of the invention, or even during the winter if the machine is installed inside.

The illustrated embodiments are only examples of the present invention and, therefore, are non-limitive. It is to be understood that many changes in the particular structure, materials, and features of the invention may be made without departing from the spirit and scope of the invention. Therefore, it is the Applicant's intention that his patent rights not be limited by the particular embodiments illustrated and described herein, but rather by the following claims interpreted according to accepted doctrines of claim interpretation, including the Doctrine of Equivalents and Reversal of Parts.

What is claimed is:

1. A method of manufacturing cold asphalt the method comprising:
providing mixing apparatus having one hopper capable of conveying matter to a mixer, an additive oil supply and pump system capable of delivering the additive oil to the mixer, and outlet from the mixer, and a controller that controls input to, mixing in, and output of the mixer;
introducing screened RAP into the hopper in the range of approximately 98% of an overall output mixture;
conveying the RAP into the mixer at a rate determined by the controller;
introducing additive oil into the oil supply and pump system in range of approximately of approximately 2% of the overall output mixture;
controlling the amount of matter conveyed to the mixer and the speed and length of mixing until a desired mixture is attained;
conveying the resulting mixture to the outlet.

2. The method according to claim 1 further introducing lime to the mixture in a range of 3-10% of the overall output mixture and reducing the amount of the overall output mixture of RAP in the range of 88-95% accordingly.

3. The method according to claim 1 screening the RAP through a ⅜ inch minus screen.

4. A product-by-process for producing cold asphalt mix produced according to a process comprising:
providing mixing apparatus having one hopper capable of conveying matter to a mixer, an additive oil supply and pump system capable of delivering the additive oil to the mixer, and outlet from the mixer, and a controller that controls input to, mixing in, and output of the mixer;
introducing screened RAP into the hopper in ratios of approximately 98%;
conveying the RAP into the mixer at a rate determined by the controller;
introducing additive oil into the oil supply and pump system in overall content ratios of 2%;
when the additive oil and RAP are sufficiently mixed as determined, the controller sends the resulting mixture to the outlet.

5. The product-by-process of claim 4 further comprising the introducing of a lime feed and conveying lime of quantity in an overall mixture content ratio of approximately 3-10% determined by the controller to the mixer to create a mixture comprised of RAP, oil, and lime and in which the additive oil is reduced to an overall mixture content ration of approximately 2% or less.
